(19) United States
(12) Patent Application Publication
(10) Pub. No.: US 2010/0114750 A1
(43) Pub. Date: May 6, 2010

(54) COMMUNICATION DEVICE AND METHOD FOR SECURING AN INTERNET BANK ACCOUNT

(75) Inventor: XIN XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City, Guangdong Province (CN); CHI MEI COMMUNICATION SYSTEMS, INC., Tu-Cheng City, Taipei County (TW)

(21) Appl. No.: 12/547,638

(22) Filed: Aug. 26, 2009

(30) Foreign Application Priority Data
Oct. 31, 2008 (CN) 200810305350.3

(51) Int. Cl. G06Q 40/00; H04L 9/32; G01S 1/00

(52) U.S. Cl. 705/35; 726/6; 342/357.09

(57) ABSTRACT

A communication device and method for securing an Internet bank account include setting an alarm password and an access password corresponding to the Internet bank account, accessing the website of the Internet bank, and generate an activation command and the access password if the alarm password is input. The communication device and method further include executing the activation command to activate a global position system to acquire location information, sending an alarm message to a receiving device of the one or more emergency dispatchers, and sending the access password to the website of the Internet bank so as to log into the Internet bank account.

### BACKGROUND

1. Technical Field

Embodiments of the present disclosure relate to data securing, and more particularly to a communication device and method for securing an Internet bank account.

2. Description of Related Art

Many banks allow people to view or manage account information of their bank accounts through the Internet, through a process known as Internet banking. Access to the account information may involve use of typing in and confirmation of a password. However, if people are forced to transfer money from their Internet bank account to another bank account, then the Internet bank cannot identify something abnormal happening.

What is needed, therefore, is an improved communication device and method for securing an Internet bank account.

### BRIEF DESCRIPTION OF THE DRAWINGS

FIG. 1 is a block diagram of one embodiment of a communication device in communication with a bank server.

FIG. 2 is a block diagram of one embodiment of the communication device including an alarm system.

FIG. 3-1 and FIG. 3-2 are flowcharts of one embodiment of a method for securing an Internet bank account using the communication device of FIG. 2.

FIG. 4 is a flowchart of one embodiment of the block S12 of FIG. 3-1.

FIG. 5 is a flowchart of one embodiment of the block S14 of FIG. 3-1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

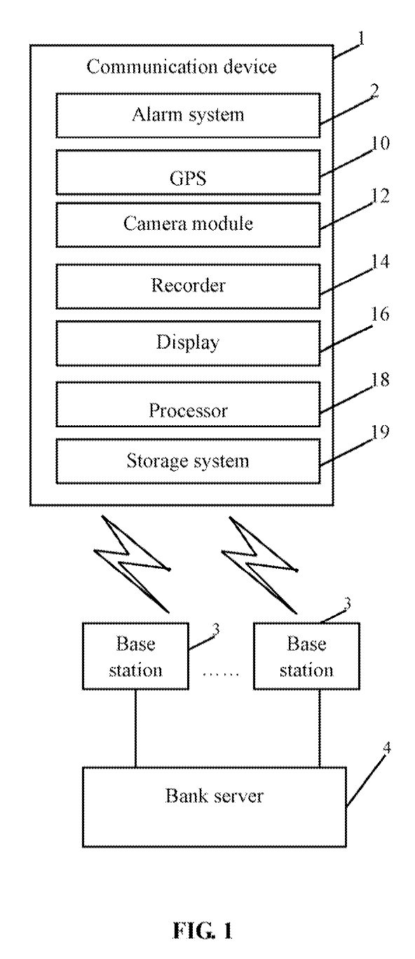

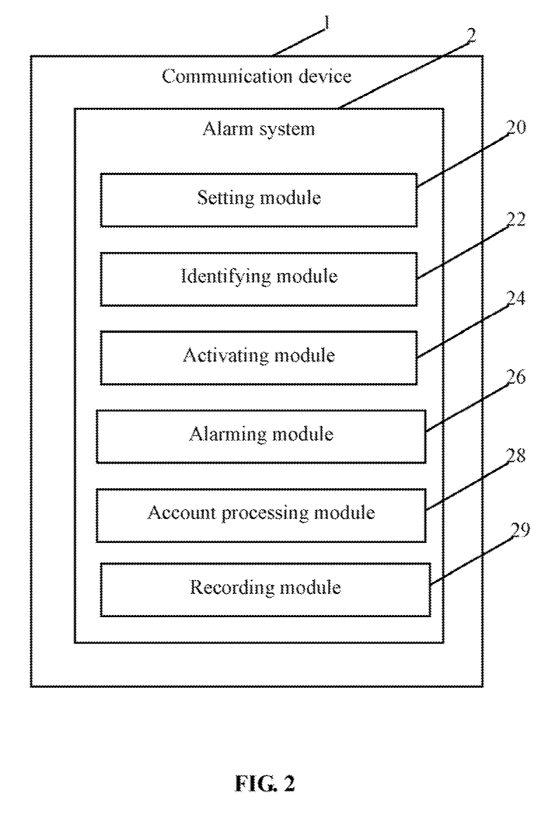

FIG. 1 is a block diagram of one embodiment of a communication device 1 in communication with a bank server 4. The communication device 1 includes an alarm system 2. The alarm system 2 may be used to send alarm messages to a receiving device of one or more emergency dispatchers (e.g., the police) when an Internet bank account of a user is in an abnormal state (e.g., under force or threat). In one embodiment, an alarm password corresponding to the Internet bank account is preset. The alarm system 2 may identify that the Internet bank account is in the abnormal state if the communication device 1 receives the alarm password. By utilizing the alarm system 2, money of the Internet bank account may be protected when people are forced to transfer money from one bank account to another bank account, such as from their Internet bank account to another person's bank account through the communication device 1.

In one embodiment, the bank server 4 may be a host computer of a bank, for example. In one embodiment, the bank server 4 may be a web server, which hosts a website of an Internet bank (e.g., the website of the bank). The website provides various webpages for people to logon, browse, or manage account information of the Internet bank account, do on-line transactions, transfer money, for example.

The communication device 1 may be a mobile phone, a personal digital assistant (PDA), a handheld computer, or any other kind of computing device. In the embodiment as shown in FIG. 1, the communication device 1 may also include a global position system (GPS) 10, a camera module 12, a recorder 14, and a display 16. The GPS 10 may locate a position of the communication device 1. The camera module 12 may capture a photo or a video, for example. The recorder 14 may record voice signals received by a microphone of the communication device 1. The display 16 may display or output visible data, such as messages, images, webpages, for example.

The communication device 1 may further include a processor 18 and a storage system 19. The processor 18 executes one or more computerized operations of the communication device 1 and other applications, to provide functions of the communication device 1. The storage system 19 stores one or more programs, such as programs of an operating system, other applications of the communication device 1, and various kinds of data, such as messages, the account information of the Internet bank account, for example. In one embodiment, the storage system 19 may be a memory of the communication device 1 or an external storage card, such as a memory stick, a subscriber identification module (SIM) card, a smart media card, a compact flash card, or any other type of memory card.

In the embodiment of FIG. 1, the communication device 1 may communicate with the bank server 4 through a plurality of base stations 3. The base stations 3 may be wireless base stations or mobile telephone base stations, for example. The user of the communication device 1 may access the bank server 4 to browse or manage the account information of an Internet bank account through the plurality of base stations 4.

The receiving device of the emergency dispatchers (e.g, the police) may be a web server providing an alarm platform of the police.

FIG. 2 is a block diagram of one embodiment of the communication device 1 including the alarm system 2. In one embodiment, the alarm system 2 includes a setting module 20, an identifying module 22, an activating module 24, an alarming module 26, an account processing module 28, and a recording module 29. The modules 20, 22, 24, 26, 28, and 29 may comprise one or more computerized operations to be executed by the processor 18 to perform one or more operations of the communication device 1. Details of these operations will be provided below.

The setting module 20 is operable to set an alarm password and an access password corresponding to an Internet bank account of a user of the communication device 1. The access password may be inputted by a user to perform regular Internet banking transactions. The alarm password may be inputted by a user to activate/invoke an alarm function when an abnormal Internet banking transaction occurs. For example, if the user is abducted by criminals and forced to transfer money from his/her Internet bank account, the alarm password may be inputted by the user.

Communication between the communication device 1 and a website of an Internet bank of the Internet bank account is established. In one embodiment, the website of the Internet bank of the Internet bank account may be provided by the bank server 4. The identifying module 22 accesses the website of the Internet bank through the established communication. The identifying module 22 receives information of the Internet bank account (e.g., account numbers) and an input password in response to user input through the communication device 1, and determines if the input password is the alarm password or the access password.

If the input password is the alarm password, the activating module 24 generates an activation command and the access password. In one embodiment, the activation command may be used to obtain current crisis information. In one embodiment, the activation command is executed to activate the GPS 10 to locate a current position of the communication device 1, activate the camera module 12 to capture a photo or a video, and/or activate the recorder 14 to record voice signals through the microphone of the communication device 1. The current crisis information may include, but are not limited to, location information of the communication device 1, captured photos/videos, and recorded voice signals. For example, the captured photos/videos and the recorded voice signals may record portrait information, voice information and dialogs to be evidences of a crime.

A photoflash lamp of the camera module 12 may be preset to be closed. Duration time of the captured video and/or the recorded voice signals may be preset by the setting module 20. The duration time may be 10 seconds, for example.

The activating module 24 acquires the location information of the communication device 1 from the GPS 10, acquires the captured photo/video, and/or the recorded voice signals. The location information may include longitude, latitude, and altitude of the position of the communication device 1. The setting module 20 may be used to set an activation interval (e.g., 3 seconds) to activate the GPS 10, the camera module 12, and/or the recorder 14 periodically, so as to acquire new/updated current crisis information. Further, the setting module 20 may be used to set an alarm interval (e.g., 3 seconds) to send the alarm message to the receiving device of the one or more emergency dispatchers, such as the police authorities.

The alarming module 26 generates an alarm message including the current crisis information. The alarming module 26 further sends the alarm message to the receiving device of the one or more emergency dispatchers. In one embodiment, the alarm message is a multimedia messaging service (MMS) message, for example. The police may track down the communication device 1 to perform a rescue according to the current crisis information in the alarm message.

In one embodiment, the account processing module 28 sends the access password generated by the activating module 24, from the communication device 1 to the website of the Internet bank, and logs into the Internet bank account. In another embodiment, for the purpose of securing the Internet bank account, the setting module 20 may be further used to set a restricted amount of the Internet bank account. The account processing module 28 receives a webpage presenting an actual amount of the Internet bank account from the website of the Internet bank, and compares the actual amount with the restricted amount.

If the actual amount is larger than the restricted amount, the account processing module 28 parses the received webpage by replacing the actual amount with the restricted amount, and displays the parsed webpage on the display 16. If the actual amount is less than the restricted amount, the account processing module 28 displays the received webpage on the display 16 directly.

The account processing module 28 may be further operable to manage the Internet bank account in response to user actions through the communication device 1. Manage of the Internet bank account may include querying account amount of the Internet bank account, transferring money of the Internet bank account, and on-line trading, for example.

The setting module 20 may be further operable to set a termination command to terminate the alarm system 2, that is, to terminate sending the alarm message to the platform of the police. For example, if the user is released, the termination command may be invoked. In one embodiment, the termination command may be invoked by pressing a preset hotkey or by inputting a character string, which includes numbers, alphabets, and/or symbols.

The activating module 24 and the account processing module 28 performs corresponding functions at the same time when the alarm password is received.

If the identifying module 22 identifies that the input password is the access password (refer to paragraph [0018]), the account processing module 28 sends the access password from the communication device 1 to the website of the Internet bank, and logs into the Internet bank account. The account processing module 28 also receives a webpage presenting an actual amount of the Internet bank account from the website of the Internet bank, and displays the received webpage on the display 16. As mentioned above, the account processing module 28 may be further operable to manage the Internet bank account in response to the user actions through the communication device 1.

The recording module 29 records all actions on the Internet bank account, and generates an action log including the recorded actions. In one embodiment, the actions may include viewing the account information, transferring the money of the Internet bank account, for example. The recording module 29 further stores the action log into the storage system 19.

FIG. 3-1 and FIG. 3-2 are flowcharts of one embodiment of a method for securing an Internet bank account using the communication device 1 of FIG. 2. Depending on the embodiment, additional blocks may be added, others removed, and the ordering of the blocks may be replaced.

In block S2, the setting module 20 sets an alarm password and an access password corresponding to an Internet bank account of a user of the communication device 1, and sets a restricted amount of the Internet bank account. As mentioned above, the access password may be inputted by a user to perform regular Internet banking transactions, and the alarm password may be inputted by a user to activate/invoke an alarm function when an abnormal Internet banking transaction occurs.

In block S4, the communication between the communication device 1 and a website of an Internet bank provided by the bank server 4 is established.

In block S6, the identifying module 22 receives information of the Internet bank account (e.g., account numbers) and an input password in response to user input through the communication device 1.

In block S8, the identifying module 22 determines if the input password is the alarm password or the access password. If the input password is the access password, the procedure goes to block S18 directly.

If the input password is the alarm password, in block S10, the activating module 24 generates an activation command and the access password.

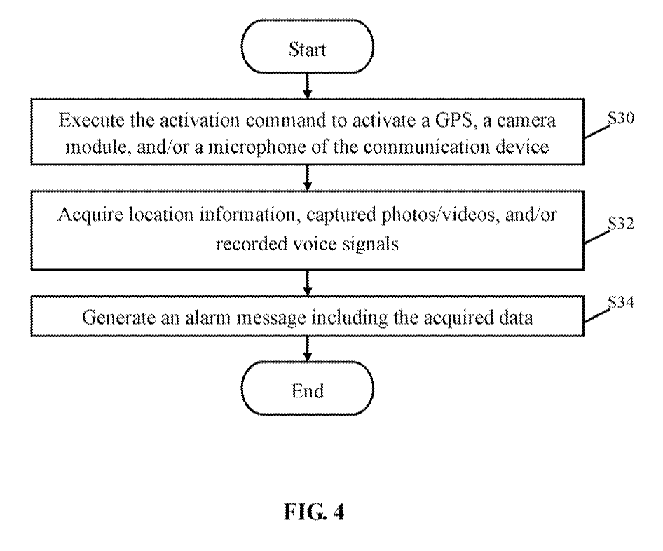

In block S12, the alarming module 26 sends an alarm message to a receiving device of the one or more emergency dispatchers. Detailed descriptions about the block S12 are described in FIG. 4.

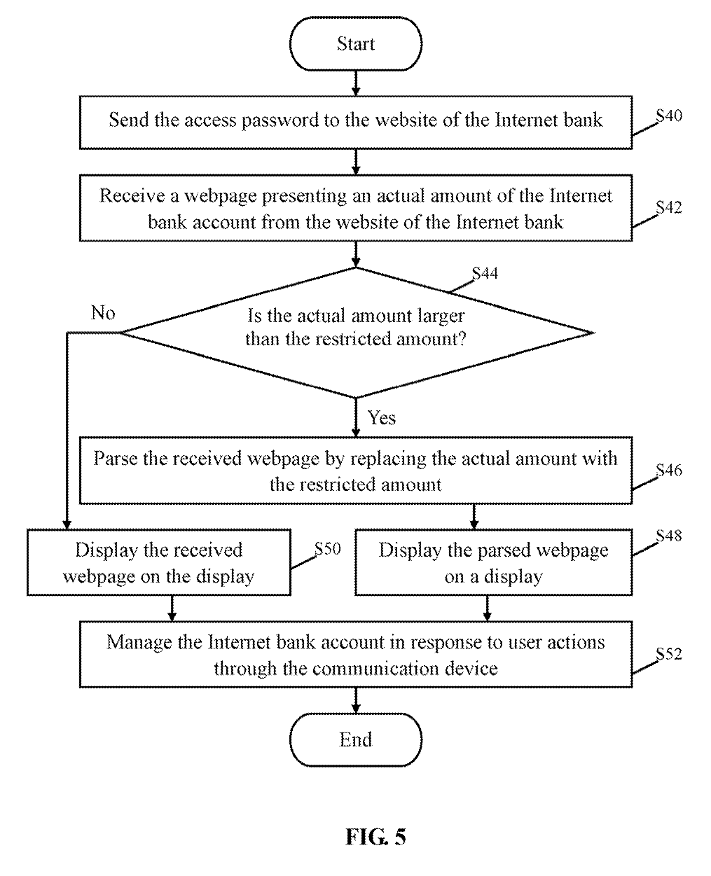

In block S14, the account processing module 28 logs into the Internet bank account by sending the access password to the website of the Internet bank, and receives account information from the website of the Internet bank. Detailed descriptions about the block S14 are described in FIG. 5.

In block S16, the recording module 29 records all actions on the Internet bank account, generates an action log including the recorded actions, and stores the action log into the storage system 19.

If the input password is the access password, in block S18, the account processing module 28 sends the access password from the communication device 1 to the website of the Internet bank, and logs into the Internet bank account.

In block S20, the account processing module 28 receives a webpage presenting an actual amount of the Internet bank account from the website of the Internet bank.

In block S22, the account processing module 28 displays the received webpage on the display 16.

In block S24, the account processing module 28 manages the Internet bank account in response to the user actions through the communication device 1.

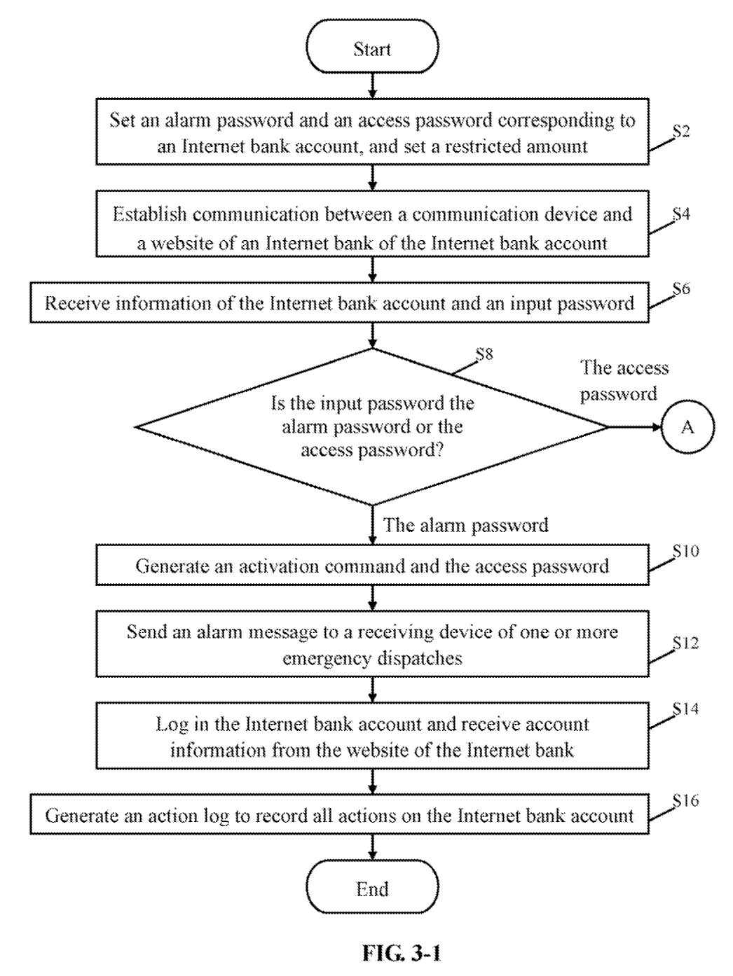

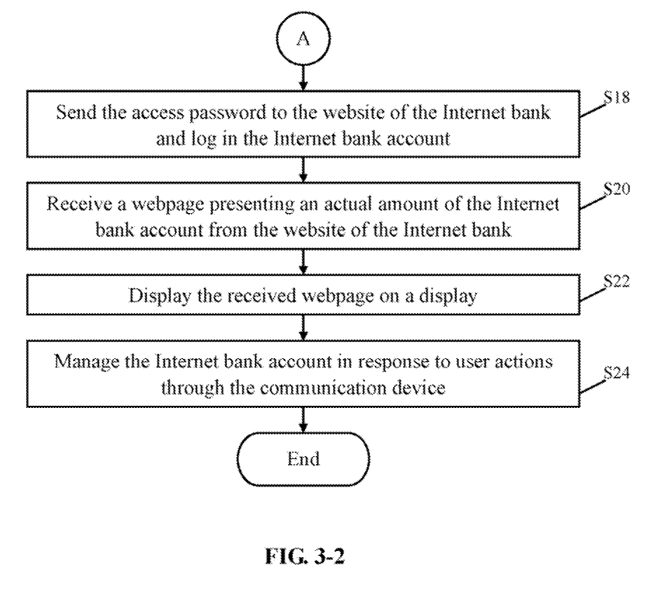

FIG. 4 is a flowchart of one embodiment of the block S12 of FIG. 3-1. Depending on the embodiment, additional blocks may be added, others removed, and the ordering of the blocks may be replaced.

In block S30, the activating module 24 executes the activation command to activate the GPS 10 to locate a position of the communication device 1, activate the camera module 12 to capture a photo or a video, and/or activate the recorder 14 to record voice signals through the microphone of the communication device 1.

In block S32, the activating module 24 acquires location information of the communication device 1 from the GPS 10, acquires the captured photo or video, and/or the recorded voice signals.

In block S34, the alarming module 26 generates the alarm message including the location information, the captured photo or video, and/or the recorded voice signals, and sends the alarm message to the receiving device of the one or more emergency dispatchers.

FIG. 5 is a flowchart of one embodiment of the block S14 of FIG. 3-1. Depending on the embodiment, additional blocks may be added, others removed, and the ordering of the blocks may be replaced.

In block S40, the account processing module 28 sends the access password from the communication device 1 to the website of the Internet bank, and logs into the Internet bank account.

In block S42, the account processing module 28 receives a webpage presenting the actual amount of the Internet bank account from the website of the Internet bank.

In block S44, the account processing module 28 compares the actual amount with the restricted amount, and determines if the actual amount is larger than the restricted amount. If the actual amount is less than the restricted amount, the procedure goes to block S50.

If the actual amount is larger than the restricted amount, in block S46, the account processing module 28 parses the received webpage by replacing the actual amount with the restricted amount.

In block S48, the account processing module 28 displays the parsed webpage on the display 16, and then the procedure goes to block S52.

If the actual amount is less than the restricted amount, in block S50, the account processing module 28 displays the received webpage on the display 16.

In block S52, the account processing module 28 manages the Internet bank account in response to user actions through the communication device 1. As mentioned above, manage of the Internet bank account may include query account amount of the Internet bank account, transfer money of the Internet bank account, on-line trading, for example.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for securing an Internet bank account using a communication device, the method comprising:
setting an alarm password and an access password corresponding to the Internet bank account;
establishing communication between the communication device and a website of an Internet bank of the Internet bank account;
accessing the website of the Internet bank;
receiving information of the Internet bank account and an input password in response to user input through the communication device;
determining if the input password is the alarm password or the access password;
generating an activation command and the access password if the input password is the alarm password;
executing the activation command to activate a global position system (GPS) of the communication device to locate a position of the communication device;
acquiring location information of the communication device from the GPS;
generating an alarm message comprising the location information, and sending the alarm message to a receiving device of one or more emergency dispatchers;
sending the access password from the communication device to the website of the Internet bank; and
logging into the Internet bank account.

2. The method according to claim 1, further comprising:
recording all actions on the Internet bank account;
generating an action log comprising the recorded actions; and
storing the action log into a storage system of the communication device.

3. The method according to claim 1, further comprising:
activating a camera module of the communication device to capture a photo or a video according to the activation command, wherein the alarm message further comprises the captured photo or video.

4. The method according to claim 1, further comprising:
activating a microphone of the communication device to record voice signals according to the activation command, wherein the alarm message further comprises the recorded voice signals.

5. The method according to claim 1, further comprising:
setting a restricted amount of the Internet bank account.

6. The method according to claim 5, further comprising:
receiving a webpage presenting an actual amount of the Internet bank account from the website of the Internet bank;
comparing the actual amount with the restricted amount, and determining if the actual amount is larger than the restricted amount;
parsing the webpage by replacing the actual amount with the restricted amount if the actual amount is larger than the restricted amount, and displaying the parsed webpage on a display of the communication device after logging into the Internet bank account; or
displaying the received webpage on the display if the actual amount is less than the restricted amount.

7. A communication device, the communication device comprising:
a global position system (GPS);
a storage system;
at least one processor; and
one or more programs stored in the storage system and being executable by the at least one processor, the one or more programs comprising:
a setting module operable to set an alarm password and an access password corresponding to the Internet bank account;
an identifying module operable to access a website of an Internet bank of the Internet bank account through communication between the communication device and the website of the Internet bank, receive information of the Internet bank account and an input password in response to user input through the communication device, and determine if the input password is the alarm password or the access password;
an activating module operable to generate an activation command and the access password if the input password is the alarm password, execute the activation command to activate the GPS to locate a position of the communication device, and acquire location information of the communication device from the GPS;
an alarming module operable to generate an alarm message comprising the location information, and send the alarm message to a receiving device of one or more emergency dispatchers; and
an account processing module operable to send the access password from the communication device to the website of the Internet bank, and log into the Internet bank account.

8. The communication device according to claim 7, wherein the one or more programs further comprises a recording module operable to record all actions on the Internet bank account, generate an action log comprising the recorded actions, and store the action log into the storage system.

9. The communication device according to claim 7, wherein the activating module is further operable to activate a camera module of the communication device to capture a photo or a video according to the activation command, wherein the alarm message further comprises the captured photo or video.

10. The communication device according to claim 7, wherein the activating module is further operable to activate a microphone of the communication device to record voice signals according to the activation command, wherein the alarm message further comprises the recorded voice signals.

11. The communication device according to claim 7, wherein the setting module is further operable to set a restricted amount of the Internet bank account.

12. The communication device according to claim 11, wherein the account processing module is further operable to receive a webpage presenting an actual amount of the Internet bank account from the website of the Internet bank, compare the actual amount with the restricted amount, parse the webpage by replacing the actual amount with the restricted amount and display the parsed webpage on a display of the communication device after logging into the Internet bank account if the actual amount is larger than the restricted amount, or display the received webpage on the display if the actual amount is less than the restricted amount.

13. A storage medium storing a set of instructions, the set of instructions capable of being executed by a processor to perform a method for securing an Internet bank account using a communication device, the method comprising:
setting an alarm password and an access password corresponding to the Internet bank account;
establishing communication between the communication device and a website of an Internet bank of the Internet bank account;
accessing the website of the Internet bank;
receiving information of the Internet bank account and an input password in response to user input through the communication device;
determining if the input password is the alarm password or the access password;
generating an activation command and the access password if the input password is the alarm password;
executing the activation command to activate a global position system (GPS) of the communication device to locate a position of the communication device;
acquiring location information of the communication device from the GPS;
generating an alarm message comprising the location information, and sending the alarm message to a receiving device of one or more emergency dispatchers;
sending the access password from the communication device to the website of the Internet bank; and
logging into the Internet bank account.

14. The storage medium as claimed in claim 13, wherein the method further comprises:
recording all actions on the Internet bank account;
generating an action log comprising the recorded actions; and
storing the action log into a storage system of the communication device.

15. The storage medium as claimed in claim 13, wherein the method further comprises:
activating a camera module of the communication device to capture a photo or a video according to the activation command, wherein the alarm message further comprises the captured photo or video.

16. The storage medium as claimed in claim 13, wherein the method further comprises:
activating a microphone of the communication device to record voice signals according to the activation command, wherein the alarm message further comprises the recorded voice signals.

17. The storage medium as claimed in claim 13, wherein the method further comprises:
setting a restricted amount of the Internet bank account.

18. The storage medium as claimed in claim 17, wherein the method further comprises:
receiving a webpage presenting an actual amount of the Internet bank account from the website of the Internet bank;
comparing the actual amount with the restricted amount, and determining if the actual amount is larger than the restricted amount;
parsing the webpage by replacing the actual amount with the restricted amount if the actual amount is larger than the restricted amount, and displaying the parsed webpage on a display of the communication device after logging into the Internet bank account; or
displaying the received webpage on the display if the actual amount is less than the restricted amount.
